(19) United States
(12) Patent Application Publication
(10) Pub. No.: US 2009/0127369 A1
(43) Pub. Date: May 21, 2009

(54) System for leveling a protective window covering

(76) Inventors: Willis J. Mullet, Gulf Breeze, FL (US); Richard S. Hand, Pace, FL (US); Darrin W. Brunk, Pensacola, FL (US)

Correspondence Address: RENNER KENNER GREIVE BOBAK TAYLOR & WEBER, FIRST NATIONAL TOWER FOURTH FLOOR, 106 S. MAIN STREET, AKRON, OH, 44308, US

(21) Appl. No.: 11/986,072

(22) Filed: Nov. 20, 2007

(51) Int. Cl. E06B 9/56; B65H 75/34

(52) U.S. Cl. 242/379; 160/23.1; 242/398

(57) ABSTRACT

A system is provided to adjust the orientation of the axis of a roll which carries a fabric storm curtain used to protect an opening in a structure. The system includes a bracket positioned at each end of the roll and a plate which is received in a recess in each bracket. The plate includes a hub which carries the roll and which has an axis aligned with the axis of rotation of the roll. The hub is positioned off center of the plate so that dependent on the orientation of plate relative to the recess, different orientations of the axis of the roll are provided.

### TECHNICAL FIELD

This invention relates to a storm curtain which is utilized to protect an opening in a structure, such as a window. More particularly, this invention relates to a system of assuring that the curtain is level so that it may be properly latched at the bottom of the opening.

### BACKGROUND ART

In geographic areas which are prone to having high wind events, such as hurricanes and the like, the need exists for the protection of openings, such as windows and doors, in buildings. Otherwise, if the high winds or wind-borne debris breaches the integrity of the structure by destroying a window or door, severe damage to the structure can be expected.

In its most simple form, one type of known protection device which can be utilized is a sheet of plywood which can be attached to the structure so as to cover the openings thereof. However, this “boarding up” procedure is not only time consuming, when time is usually of the essence, but also can disfigure the exterior of the structure upon frequent installation and removal. In addition, plywood has a limited life, particularly after becoming wet. Finally, storing and maintaining an inventory of plywood sheets can be problematic.

As a result, a number of temporarily installable or permanently installed devices have been developed to be used as alternatives to plywood. For example, metallic shutters consisting of a plurality of hinged slats can be provided adjacent to a window and can be rolled up by a hand crank or a motor when not in use. However, these devices are not only costly, but also they do not provide the necessary wind or water resistant seal, irrespective of whether they are mounted on the windward or leeward side of the building.

More recently, fabric-based systems have been developed which are much less costly than the metallic shutters or other devices, and which can provide a seal for the openings in the structure. In their simplest form, these systems include a sheet of fabric which is strong enough to withstand high winds and the forces of wind-borne debris without rupturing. These fabric sheets may be sealed on all four edges, thus providing a seal for the structure even if the glass of a window, for example, has been broken, or a door blown open.

In such systems, the fabric is oftentimes rolled up and stored in an upper housing and is payed out from the roll as the fabric curtain is pulled down between two side rails. When the fabric reaches the bottom sill of the structure, it is typically held in place by devices which engage the curtain at the side rails or across the entire lateral extent of the sill between the side rails. However, in order to properly lock or hold the curtain in place in this manner, the curtain must be level or otherwise hang straight. When the frame of the window is not level, such becomes problematic and oftentimes the window frame itself must be shimmed or otherwise adjusted so that the curtain will hang straight. But such a process is not only time consuming but also it might otherwise affect the structural integrity of the building.

The need exists, therefore, for a system of quickly and conveniently leveling a protective covering for an opening in a structure.

### DISCLOSURE OF THE INVENTION

It is thus an object of one aspect of the present invention to provide a system for leveling a storm protection cover carried by a storage roll having a counterbalance spring.

It is an object of another aspect of the invention, as above, in which the leveling system utilizes the perch which can also be used to adjust the pretension of the counterbalance spring in the storage roll.

These and other objects of the present invention, as well as the advantages thereof over existing prior art forms, which will become apparent from the description to follow, are accomplished by the improvements hereinafter described and claimed.

In general, an apparatus for orienting the axis of a roll in accordance with the present invention includes a bracket adapted to be positioned at at least one end of the roll. A recess is formed in the bracket. A hub is carried off center of a plate, and the hub is adapted to carry the end of the roll and is aligned with the axis of the roll. The plate is selectively received in the recess in different orientations so as to provide different orientations of the axis of the roll.

In accordance with another aspect of the invention, an apparatus for covering an opening in a structure includes a roll having an axis of rotation. Fabric is positioned on the roll and is movable from a positioned stored on the roll to a position extended from the roll to cover the opening. At least one plate has a hub which carries an end of the roll and which has an axis aligned with the axis of rotation of the roll. The hub is carried by the plate off center of the plate. A bracket is positioned at the end of the roll and is provided with a recess. The plate is selectively received in the recess in different orientations so as to provide different orientations of the axis of rotation of the roll.

A preferred system to level a storm protection cover carried by a storage roll made in accordance as described herein substantially improves the art and otherwise accomplishes the objects of the present invention.

### BRIEF DESCRIPTION OF THE DRAWINGS

FIG. 1 is a perspective view of a storm cover of the present invention protecting a window and having the header removed.

FIG. 2 is an enlarged fragmented perspective view of that which is circled in FIG. 1.

FIG. 3 is an enlarged fragmented perspective view of that which is circled in FIG. 1.

FIG. 4 is a top, front perspective view of an end bracket and perch block made in accordance with the present invention.

FIG. 5 is a top, rear perspective view of that which is shown in FIG. 4.

FIG. 6 is an exploded perspective view of the bracket and perch block shown in FIG. 4.

FIG. 7 is an elevational view showing the perch block and the bracket of FIG. 4 in one orientation.

FIG. 8 is an elevational view like FIG. 7 but showing the perch block and the bracket of FIG. 4 in a second orientation.

FIG. 9 is an elevational view like FIGS. 7 and 8 but showing the perch block and the bracket of FIG. 4 in a third orientation.

FIG. 10 is a top, front perspective view of an end bracket and perch block made in accordance with an alternative embodiment of the present invention.

FIG. 11 is a top, rear perspective view of that which is shown in FIG. 10.

FIG. 12 is an exploded perspective view of the bracket and perch block shown in FIG. 10.

FIG. 13 is an elevational view showing the perch block and bracket of FIG. 10 in one orientation.

FIG. 14 is an elevational view like FIG. 13 but showing the perch block and the bracket of FIG. 10 in a second orientation.

FIG. 15 is an elevational view like FIG. 13 but showing the perch block and the bracket of FIG. 10 in a third orientation.

### PREFERRED EMBODIMENT FOR CARRYING OUT THE INVENTION

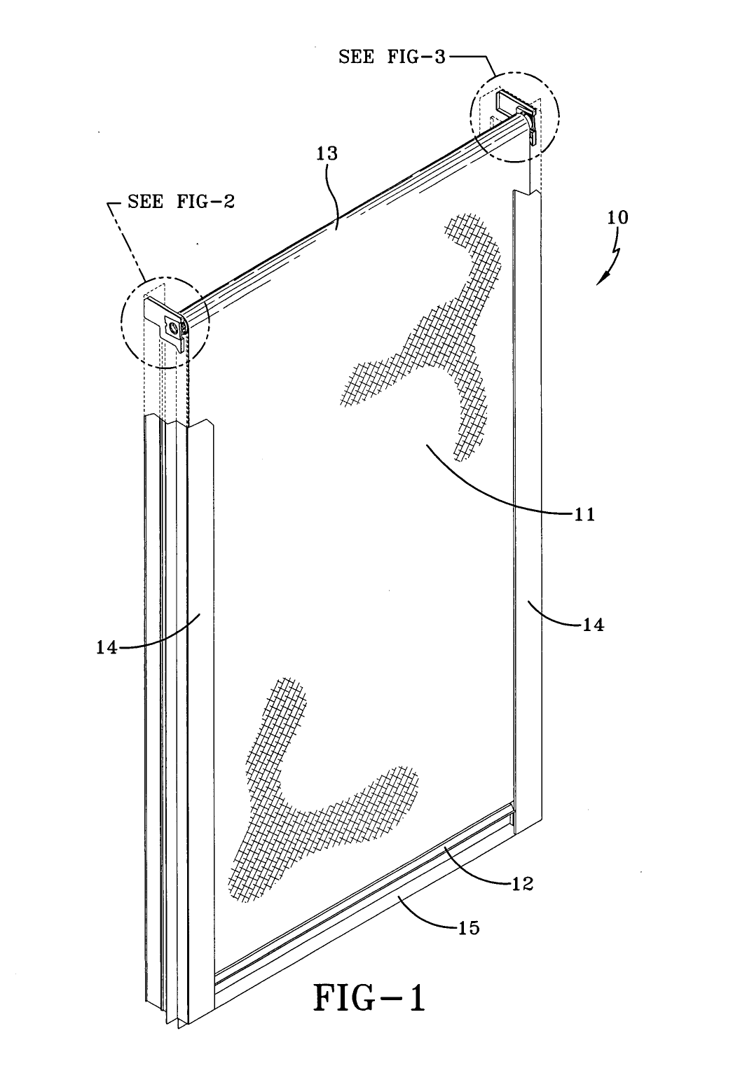

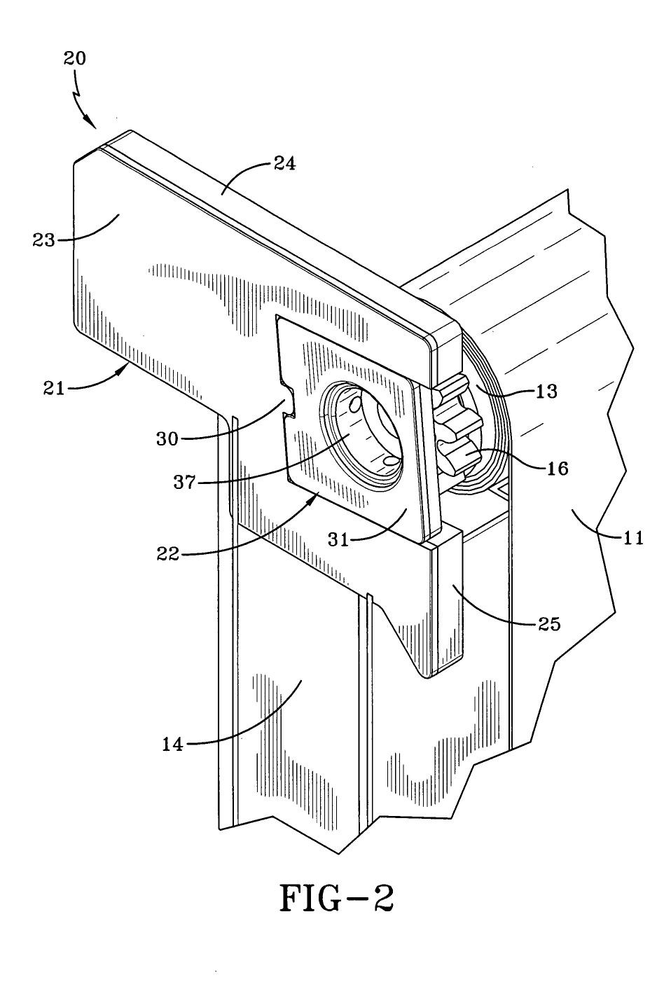

A storm curtain assembly is generally indicated by the numeral 10 and is shown in FIG. 1 as covering a window. Assembly 10 includes a fabric curtain 11 which has a bar 12 at one end and which can be connected to a roll 13 at its other end so that it can be rolled up and stored on the roll 13 positioned in a header (removed in FIG. 1 for clarity). Curtain 11 stored on roll 13 can be pulled downwardly between spaced side rails 14 to be received and held in a bottom sill 15, as shown in FIG. 1. Oftentimes the movement of roll 13 is motorized, and in such instances a driven gear 16 (FIG. 2) may be provided. Bar 12 is typically held in place by devices positioned in side rails 14 at the bottom thereof, or by a device extending between side rails 14 along the entire sill 15. Such a device is shown, for example, in U.S. patent application Ser. No. 11/799,357 for the reference to which is made for whatever details may be necessary to fully understand the present invention. Where utilizing these types of locking devices, it is important that the curtain 11 be properly aligned with the axis of rotation of roll 13 being parallel to the orientation of the device holding the bar 12 so that the bar 12 can be fully engaged. When so engaged in a manner known in the art, curtain 11 can protect the window and structure from damage which might be caused by high wind events.

The system to establish the proper orientation of the curtain of the present invention is indicated generally by the numeral 20. System 20 includes a bracket generally indicated by the numeral 21 and a perch block generally indicated by the numeral 22 which are preferably provided at each end of the roll 13 at the top of rails 14. However, it is possible that one system 20 can be provided only at one end of roll 13 without departing from the concept of this invention.

Each bracket 21 includes a plate 23 having a peripheral thickness as shown, for example, by the generally horizontal top surface 24 and the generally vertical front surface 25. Plates 23 are carried by side rails 14, and each plate 23 is provided with a generally U-shaped recess 26 which opens into front surface 25. Recess 26 thus includes opposed top and bottom sidewalls 27 and 28, respectively, and a base wall 29 extending between sidewalls 27 and 28. Base wall 29 is provided with a lug 30 positioned generally centrally thereof and having a height so that it extends into recess 26 at a predetermined distance, as will hereinafter be more fully discussed. It should be noted that while sidewalls 27and 28 are preferably not parallel to top surface 24, for reasons to also be hereinafter discussed, sidewalls 27 and 28 could be parallel to top surface 24 without departing from the concepts of the present invention.

Each perch block 22 includes a plate 31 which is shown as being generally square, having four sides 32, 33, 34, and 35 of generally the same size as the thickness of plate 23. However, as will hereinafter become evident, plate 31 could be shaped as any regular polygon having an even number of sides such as a hexagon or octagon. The distance between opposed sides 32 and 34 and the distance between opposed sides 33 and 35 should approximate the distance between sidewalls 27 and 28 of brackets 21 so that the plate 31 can be snugly received in recess 26. Likewise, if plate 31 were a regular polygon other than a square, the distance between opposed sides of that polygon would generally equal the distance between sidewalls 27 and 28.

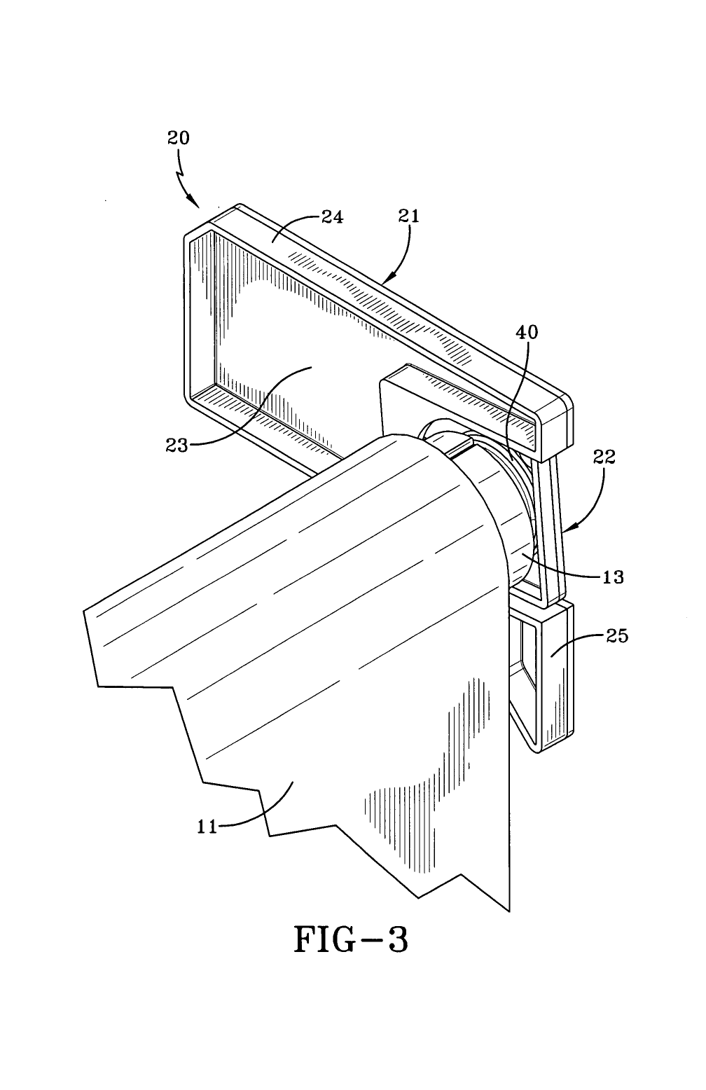

One of the sides of plate 31, shown as side 32, is provided with a notch 36, the depth of which approximates the height of lug 30 of bracket plate 23. An aperture 37 is formed through plate 31 and a hollow perch hub 38 extends rearwardly from plate 31 at aperture 37. Hub 38 is generally cylindrical and is provided with a plurality of peripheral grooves 39 which, as will hereinafter be more fully described, are adapted to engage the counterbalance spring 40 (FIG. 3) of roll 13. As such, the center 41 of aperture 37 and perch hub 38 defines the axis of roll 13. It is important to note that the aperture 37, hub 38, and their center 41 are not located at the center of plate 37. That is, aperture 37 and hub 38 are off center of plate 37, and while their center 41 is generally equidistant from sides 33 and 35 of plate 31, center 41 is closer to side 34 than it is to side 32. The distance that center 41 is closer to side 34 than it is to side 32 is a distance generally equal to the height of lug 30 or the depth of notch 36.

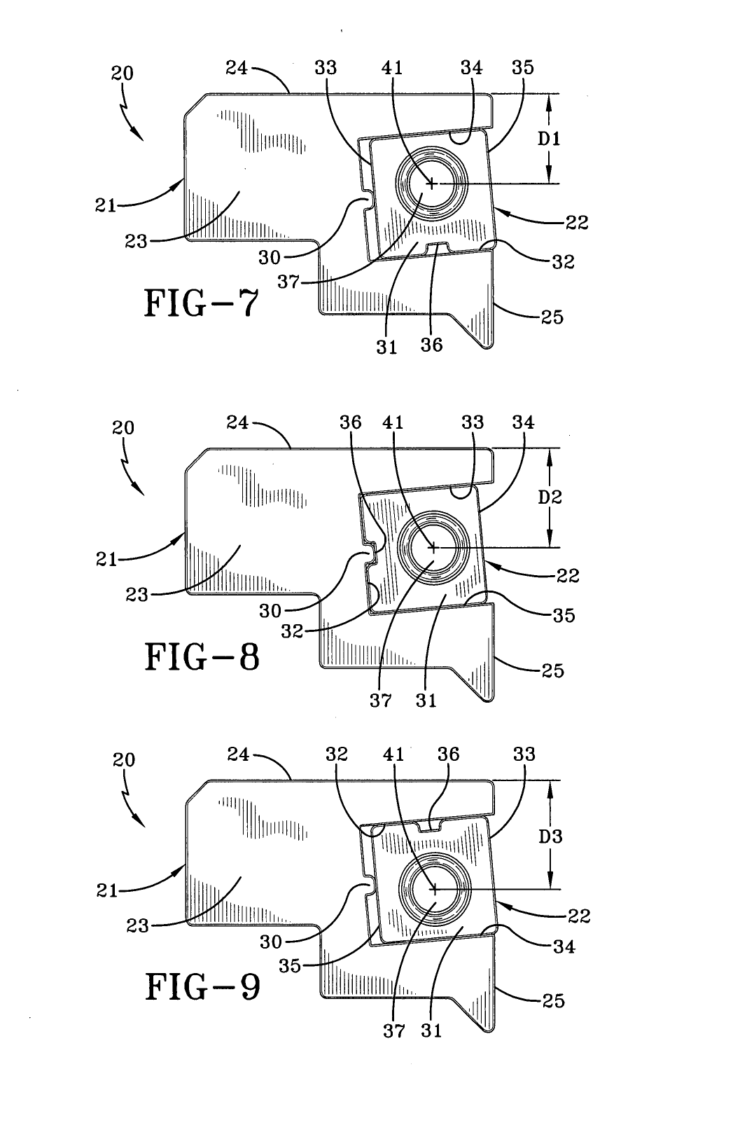

This configuration permits the user to position the axis of roll 13 at three different locations at each end of roll 13. Such is shown in FIGS. 7-9. In FIG. 7 it can be seen that if plate 31 is inserted into recess 26 such that edge 33 of plate 31 is adjacent to lug 30, the center 41 of rotation of roll 13 is at its highest position, a distance D1 from a reference point at the top 24 of bracket plate 23. As shown in FIG. 8, when plate 31 is inserted into recess 26 such that edge 32 is inserted first, lug 30 is received in notch 36 and the center 41 of rotation of roll 13 is at its most central position, a distance D2 from the top 24 of bracket plate 23, D2 being larger than D1. As shown in FIG. 9, if plate 31 is inserted into recess 26 such that edge 35 of plate 31 is adjacent to lug 30, the center 41 of rotation of roll 13 is at its lowest position, a distance D3 from the top 24 of bracket plate 23, distance D3 being larger than distance D2.

It should thus be evident that by adjusting the orientation of plate 31 in recess 31 at each end of roll 13, proper alignment of the axis of roll 13 can be obtained. Specifically, one must first determine if any skewing of roll 13 is required, and if so, the extent thereof. If there is a fairly significant misalignment, the system 20 may have to be configured as shown in FIG. 7 at one end of roll 13 and configured as shown in FIG. 9 at the other end of roll 13.

It should be pointed out that once the desired orientation is determined, perch block 22 can be used to pretension spring 40. To do so, one can merely slide plate 31 out of its recess 26 at one end of roll and rotate it in 360 degree increments until the desired tension is on spring 40. Then the plate 31 can be reinserted in its recess 26, and because the tensioning has been done in 360 degree increments, the orientation of plate 31 relative to recess 26 will remain as previously established. As previously described, while sidewalls 27 and 28 could be parallel to top surface 24 of plate 23, the fact that they are not could potentially assist the user in the pretensioning process in that the plate 31 at the other end of roll 13 is less likely to accidentally slide out of its bracket 21 while the spring is being pretensioned.

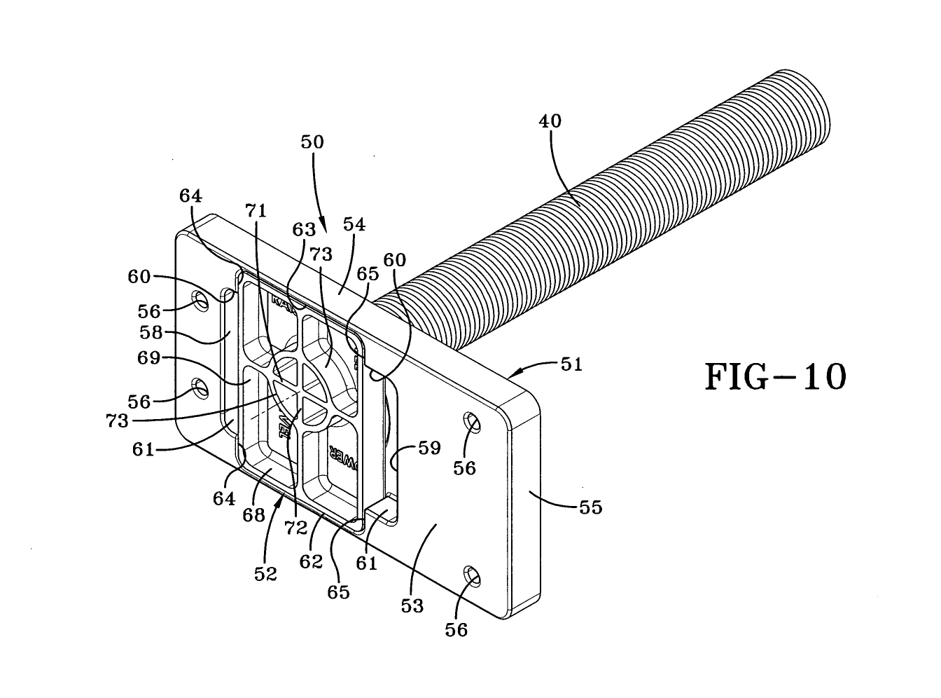

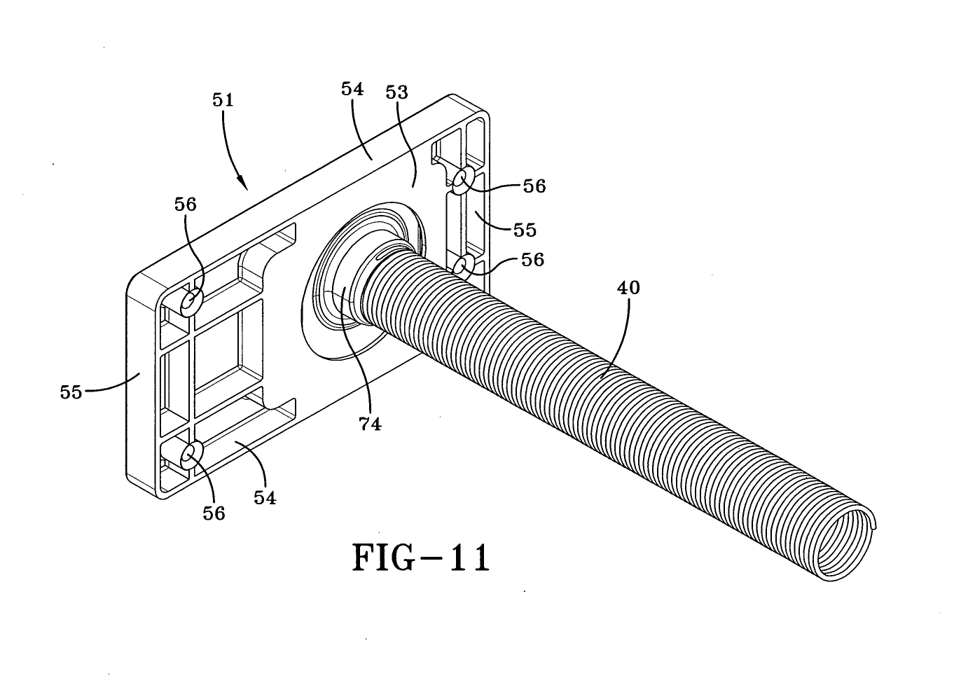

Another embodiment of the system to establish the proper orientation of the curtain is shown in FIGS. 10-15 and indicated generally by the numeral 50. System 50 includes a bracket generally indicated by the numeral 51 and a perch block generally indicated by the numeral 52 which are preferably provided at each end of roll 13.

Each bracket 51 includes a generally rectangular plate 53 having a peripheral thickness as shown, for example, by opposed top and bottom surfaces 54 and opposed front and rear surfaces 55. Plates 53 can be provided with mounting apertures 56 to enable plates 53 to be readily attached to side rails 14. Each plate 53 is provided with a generally cross-shaped recess indicated generally by the numeral 57. Recess 57 can be said to be made up of a horizontal rectangular recess portion having opposed end walls 58, 59 and opposed side edges 60, 61 and an intersecting vertical rectangular recess portion having opposed end walls 62, 63 and opposed side edges 64, 65. It should be noted that the center of the horizontal recess portion is offset from the center of the vertical recess portion. That is, end wall 58 is closer to side edge 64 than end wall 59 is to side edge 65, as will be hereinafter discussed.

Each perch block 52 includes a plate 66 which is generally rectangular and of a size of the horizontal and vertical recess portions of cross-shaped recess 57. Thus, plate 66 has four sides 67, 68, 69, and 70 of generally the same size as the thickness of plate 53. Generally horizontal ribbing 71 extends between sides 69 and 70 and generally vertical ribbing 72 extends between sides 67 and 68 to provide block 52 with suitable strength. A generally circular rib 73 is provided around the intersection of ribbing 71 and 72. Rib 73 supports a perch hub 74, which can be identical to hub 38 and which carries spring 40 in the same manner. As such, the center of hub 74 and the intersection of ribbing 71 and 72 defines the axis of roll 13. It is important to note that the intersection of ribbing 71 and 72 and thus hub 74 is off center of plate 66. Thus, which the center of hub 74 and the intersection or ribbing 71 and 72 are generally equidistant from plate sides 69 and 70, they are closer to side 67 than they are to side 68.

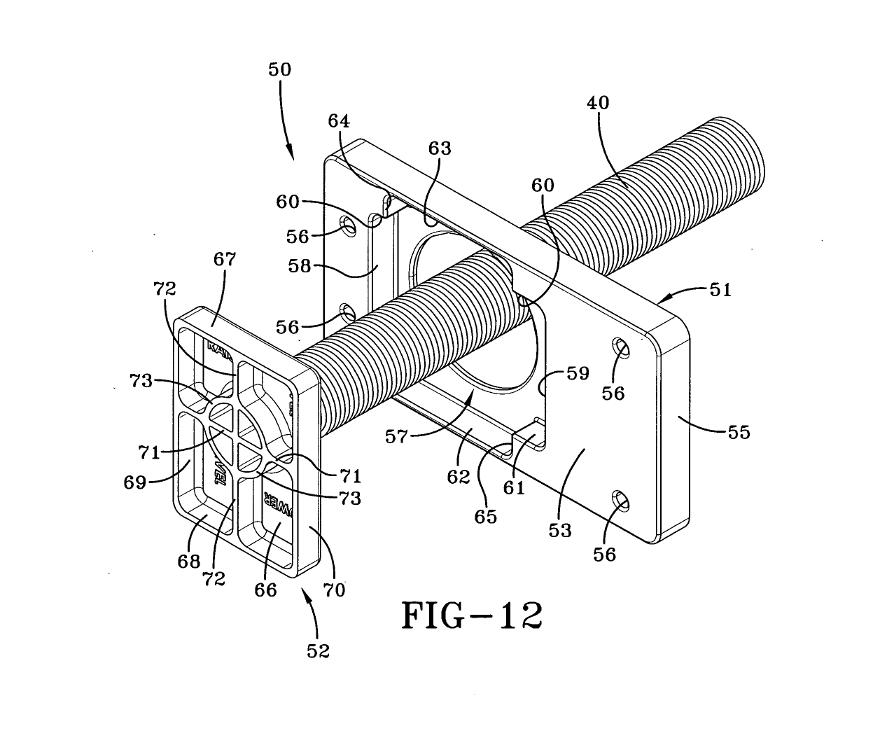

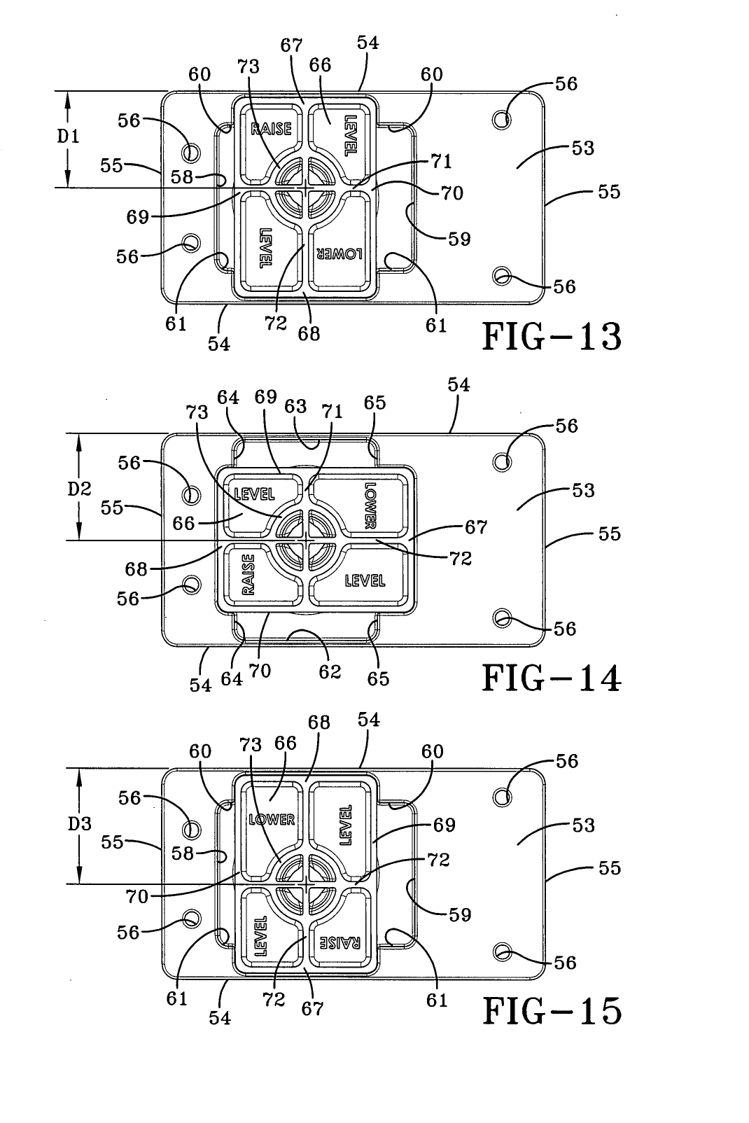

This configuration permits the user to position the axis of roll 13 at three different locations at each end of roll 13. Such is shown in FIGS. 13-15. In FIG. 13 it can be seen that if plate 66 is inserted into the vertical portion of recess 57 such that side 67 of plate 66 is adjacent to end wall 63 of the vertical recess portion, the center of roll 13 is at its highest position, a distance D1 from the top surface 54 of plate 53. In this position, if desired, upright indicia, such as the word RAISE, may be imprinted on plate 66 to indicate to the user that in this position the axis of roll 13 is raised.

As shown in FIG. 14, when plate 66 is inserted into the horizontal portion of recess 57 such that side 67 of plate 66 is adjacent to end wall 58 of the horizontal recess portion, the center of roll 13 is at its most central position, a distance D2 from the top surface 54 of plate 53. In this position, upright indicia, such as the words LEVEL, may be imprinted on plate 66 to indicate to the user that in this position the axis of roll 13 is in its center or level condition. It should be noted that the fact that the center of the horizontal recess portion is offset from the center of the vertical recess portion, as previously described, allows the center of hub 74 to be centered between side edges 64 and 65 of the vertical recess portion. As such, plate 66 should not be placed in horizontal portion of recess 66 with its side 68 adjacent to end wall 58 of the horizontal recess portion, because the center of hub 74 would not be appropriately positioned. The user could readily observe such misplacement because the word LEVEL would be upside down.

As shown in FIG. 15, when plate 66 is inserted into the vertical portion of recess 57 such that side 67 of plate 66 is adjacent to end wall 62 of the vertical recess portion, the center of roll 13 is at its lowest position, a distance D3 from the top surface 54 of plate 53. In this position, upright indicia such as the word LOWER may be imprinted on plate 66 to indicate to the user that in this position the axis of roll 13 is lowered.

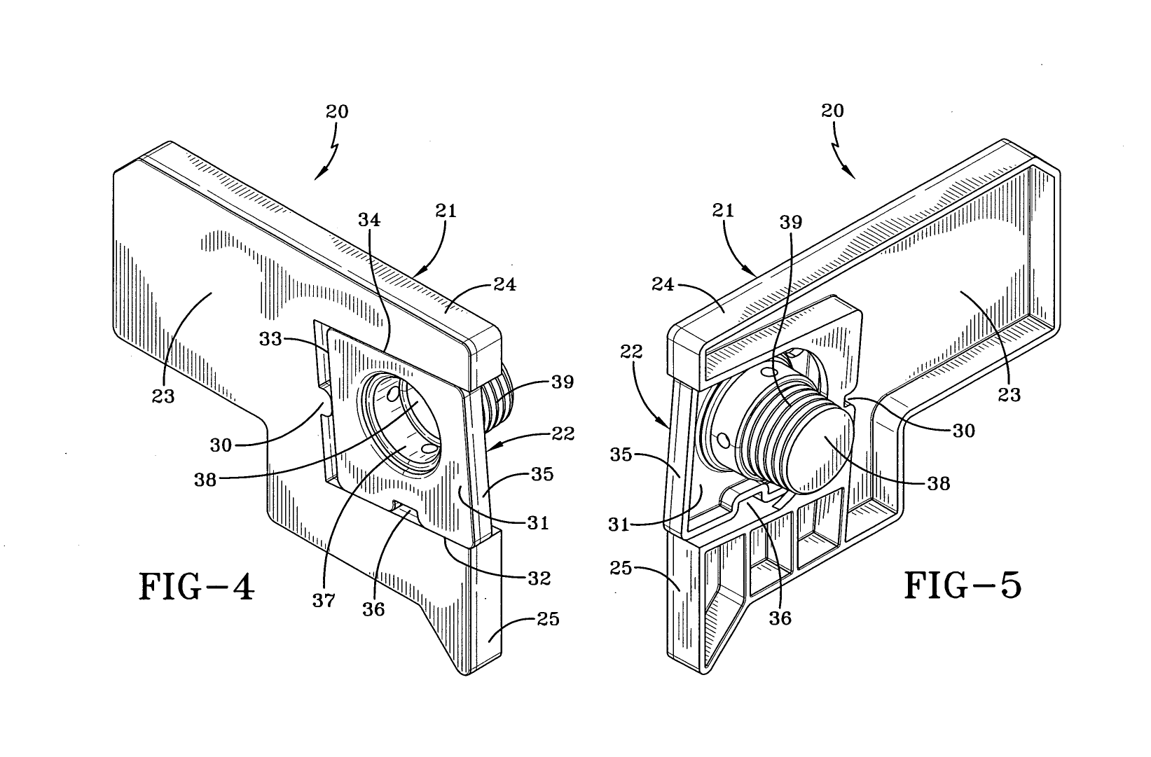

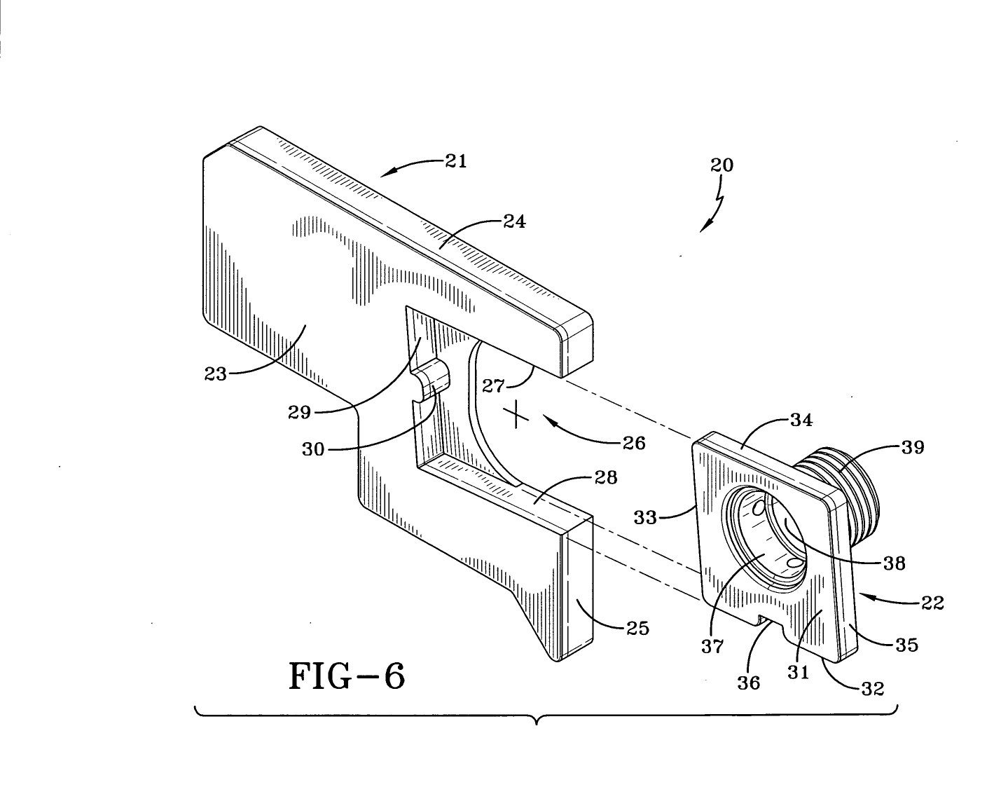

It should also be understood that the embodiment of FIGS. 10-15 can be used in the same manner on the embodiment of FIGS. 4-9 to properly align roll 13 and to pretension spring 40.

In view of the forgoing, it should be evident that a leveling system constructed as described herein accomplishes the objects of the invention and otherwise substantially improves the art.

What is claimed is:

1. Apparatus for orienting the axis of a roll comprising a bracket adapted to be positioned at least one end of the roll, a recess in said bracket, a plate, and a hub carried off center of said plate and adapted to carry the end of the roll, said hub being aligned with the axis of the roll, said plate being selectively received in said recess in different orientations so as to provide different orientations of the axis of the roll.

2. The apparatus of claim 1 wherein said plate is generally shaped as a regular polygon having an even number of sides.

3. The apparatus of claim 2 wherein said plate is generally square having a first side opposed to a second side and a third side opposed to a fourth side.

4. The apparatus of claim 3 wherein said hub is generally equally spaced from said third and fourth sides but is closer to said second side than to said first side.

5. The apparatus of claim 4 wherein said recess has opposed first and second sidewalls and a base wall extending between said first and second sidewalls.

6. The apparatus of claim 4 wherein said bracket includes a top surface and said first and second sidewalls are not parallel to said top surface.

7. The apparatus of claim 4 wherein said base wall has a lug extending outwardly therefrom and said first side has a notch formed therein such that in one orientation where said first side is adjacent to said base wall, said lug is received in said notch to provide a first orientation of the axis of the roll.

8. The apparatus of claim 7 wherein when said third side is adjacent to said base wall, a second orientation of the axis of the roll is provided.

9. The apparatus of claim 8 wherein when said fourth side is adjacent to said base wall, a third orientation of the axis of the roll is provided.

10. The apparatus of claim 1 wherein the roll is provided with a counterbalance spring and said hub is adapted to carry the spring such that when said plate is rotated, the spring is tensioned.

11. The apparatus of claim 1 wherein said recess includes a first generally rectangular portion and a second generally rectangular portion intersecting said first portion.

12. The apparatus of claim 11, said plate being received in said first portion in one orientation to provide a first orientation of the roll and being received in said first portion in a second orientation to provide a second orientation of the roll.

13. The apparatus of claim 12, said plate being received in said second portion to provide a third orientation of the roll.

14. Apparatus for covering an opening in a structure comprising a roll having an axis of rotation, fabric positioned on said roll and movable from a position stored on said roll to a position extended from said roll to cover the opening, at least one plate having a hub carrying an end of said roll and having an axis aligned with the axis of rotation of said roll, said hub being carried by said plate off center of said plate, at least one bracket positioned at the end of said roll, and a recess in said bracket, said plate being selectively received in said recess in different orientations so as to provide different orientations for the axis of rotation of said roll.

15. The apparatus of claim 14 wherein said plate is generally square having a first side opposed to a second side and a third side opposed to a fourth side.

16. The apparatus of claim 15 wherein said hub is generally equally spaced from said third and fourth sides but is closer to said second side than to said first side.

17. The apparatus of claim 16 wherein said recess has opposed first and second sidewalls and a base wall extending between said first and second sidewalls.

18. The apparatus of claim 16 wherein said bracket includes a top surface and said first and second sidewalls are not parallel to said top surface.

19. The apparatus of claim 16 wherein said base wall has a lug extending outwardly therefrom and said first side has a notch formed therein such that in one orientation where said first side is adjacent to said base wall, said lug is received in said notch to provide a first orientation of the axis of said roll.

20. The apparatus of claim 19 wherein when said third side is adjacent to said base wall, a second orientation of the axis of said roll is provided.

21. The apparatus of claim 20 wherein when said fourth side is adjacent to said base wall, a third orientation of the axis of said roll is provided.

22. The apparatus of claim 14 wherein said roll is provided with a counterbalance spring and said hub is adapted to carry said spring such that when said plate is rotated, said spring is tensioned.

23. The apparatus of claim 14 wherein said recess includes a first generally rectangular portion and a second generally rectangular portion intersecting said first portion.

24. The apparatus of claim 23, said plate being received in said first portion in one orientation to provide a first orientation of the roll and being received in said first portion in a second orientation to provide a second orientation of the roll.

25. The apparatus of claim 24, said plate being received in said second portion to provide a third orientation of the roll.
